(19) United States
(12) Patent Application Publication
(10) Pub. No.: US 2026/0236293 A1
(43) Pub. Date: Aug. 13, 2026

(54) SYSTEM AND METHOD FOR PRIORTIZING UPLOADED DOCUMENTS FOR OPTICAL CHARACTER RECOGINITION (OCR) PROCESSING

(71) Applicant: KYOCERA DOCUMENT SOLUTIONS, INC., Osaka (JP)

(72) Inventors: Benny WONG, Concord, CA (US); Selim ZAMAN, San Mateo, CA (US)

(73) Assignee: KYOCERA DOCUMENT SOLUTIONS, INC., Osaka (JP)

(21) Appl. No.: 19/053,306

(22) Filed: Feb. 13, 2025

(51) Int. Cl. G06F 9/48; G06V 30/10

(52) U.S. Cl. CPC G06F 9/4881; G06V 30/10

(57) ABSTRACT

A system and method for optimizing OCR (optical character recognition) processing on a bulk of uploaded documents are disclosed. The system and method categorize the uploaded documents to large documents and small documents based on their file sizes in comparison with a predetermined file size threshold. The small documents are sent to at least one OCR job queue. The large documents are split into a number of segmented small document files, which are then sent to the at least one OCR job queue. The system and method prioritize the documents files of the at least one OCR job queue so that the small documents have a higher priority than the segmented small document files.

### FIELD OF THE INVENTION

The present invention relates to a system and method for managing uploaded documents. In particular, the present invention relates to an OCR performance optimization system for prioritizing uploaded documents for the OCR processing.

### DESCRIPTION OF THE RELATED ART

Optical Character Recognition (OCR) is a technology that converts a scanned image of printed text into machine readable PDFs. When performing the OCR on multiple scanned documents uploaded in bulk, users experience a long wait time due to the serial processing of the multiple documents. It is because for larger documents, it takes longer time to perform the OCR than smaller documents.

Therefore, the present invention aims at improving the efficiency and accuracy of the OCR performance on documents, in particular, on documents loaded in bulk. Currently, there are no document managing systems and methods that can solve this problem without requiring manual intervention.

### SUMMARY OF THE INVENTION

A method for improving OCR (optical character recognition) performance of uploaded documents is disclosed. The method categorizes the plurality of uploaded documents based on a predetermined threshold to categorize large documents and small documents, wherein the large documents are larger than the predetermined threshold. The method sends the small documents, as small document files, to an OCR job queue, and divides each of the large documents into multiple segmented document files, in which each of the multiple segmented documents is equal or less than the predetermined threshold. The multiple segmented document files are sent to the OCR job queue. The method determines priorities of the small document files and the multiple segmented document files of each of the large documents, and performs the OCR on at least one OCR node on the small document files and the number of segmented document files based on the priority.

In the above method, the predetermined threshold is determined based on a page count limit and a resolution limit, and the threshold is saved in a configuration file relative to a cluster of OCR nodes.

The method further inserts markers into the multiple segmented document files after the large documents are divided. Each of the markers defines a location of individual segmented document file in the large documents and are used to track segments that belong to a same document. After the OCR performances are completed, the method concatenates all of the number of segmented document files after OCR to restore the large documents according to the markers, wherein the restored documents are PDF searchable documents. The markers belonging to a same large document are saved together in a database and are discarded after the OCR performance is completed and all the number of segmented document files are combined to restore the same large document based on the markers.

The markers belonging to the same large document are saved together in a database and are discarded after the OCR performance is completed and all the multiple segmented document files are combined to restore the same large document based on the markers

Further, the large documents are divided based on their file sizes in relative to the predetermined threshold, the file sizes are calculated based on a page count and a resolution.

The priorities of the small document files and the multiple segmented document files are determined in a manner that the small document files have higher priority levels than the multiple segmented documents and the multiple segmented document files are processed in an order of first-in-first-out order. The priorities may also be determined based on processing time of each of the small document files and the multiple segmented document files.

In the above method, if only one OCR node is used for processing the OCR, the OCR node processes the small document files first and then the multiple segmented document files. If there is more than one OCR node, further comprising sending the multiple segmented document files to different OCR nodes for processing.

If there are more than one OCR node, the above method further comprises sending the multiple segmented document files to different OCR nodes for processing.

If the at least one OCR node has reached maximum number of OCR jobs the at least one OCR node is able to handle, the above method further comprises assigning at least one additional OCR node to perform the OCR.

Moreover, in the above method, the priorities are determined based on processing time of each of the small document files and the multiple segmented document files.

Another method for improving optical character recognition (OCR) performances on a plurality of uploaded documents is enclosed. The method categorizes the plurality of uploaded documents based on their file sizes in comparison with a predetermined threshold, wherein documents having files sizes larger than the predetermined threshold are considered as large documents and documents having file sizes no greater than the predetermined threshold are considered as small documents. The method sends the small documents as small document files to an OCR job queue, and divides each of the large documents into multiple segmented document files, wherein each of the multiple segmented documents is no greater than the predetermined threshold. The method further inserts markers into the multiple segmented document files, each of the markers defining a location of individual segmented document file in the large documents and used to track segments that belong to a same document, sends the multiple segmented document files to the OCR job queue, distributes the small document files and the multiple segmented document files to at least one OCR node, performs the OCR on the small document files and the multiple segmented document files, and after the OCR performances are completed, concatenating all of the number of segmented document files after OCR to restore the documents according to the markers of the number of segmented documents, wherein the restored documents are PDF readable documents.

Each of the file sizes is calculated from a page count and a resolution, and the predetermined threshold are determined based on a page count limit and a resolution limit, and the predetermined threshold is saved in configuration file relative to a cluster of OCR nodes.

The method further comprises determining priorities of the small document files and the multiple segmented document files of each of the large documents.

The priorities are determined in a manner that the small document files have higher priority levels than the multiple segmented documents and the multiple segmented document files are processed in an order of first-in-first-out order.

In the method, if only one OCR node is used for processing the OCR, the OCR node will process the small document files first and then the multiple segmented document files.

Further, if there are more than one OCR node, the method further comprises sending the multiple segmented document files to different OCR nodes for processing.

A system for performing Optical Character Recognition (OCR) on bulk uploaded document is further disclosed. The system comprises a storage for storing a plurality of uploaded documents, and a managing device accessible to the plurality of uploaded documents stored in the storage, The managing device comprises a processor, wherein the storage further stores medium-readable instructions, which when executed, causes the processor to categorize the plurality of uploaded documents based on a predetermined threshold to categorize large documents and small documents, wherein the large documents are larger than the predetermined threshold, send the small documents, as small document files, to an OCR job queue, divide each of the large documents into multiple segmented document files, wherein each of the multiple segmented documents is equal or less than the predetermined threshold, and the multiple segmented document files are considered as small documents, send the multiple segmented document files to the OCR job queue, determine priorities of the small document files and the multiple segmented document files of each of the large documents, and perform the OCR on at least one OCR node on the small document files and the number of segmented document files based on the priority.

In the above system, the large documents are divided based on the predetermined threshold, and the predetermined threshold includes a page count threshold and a resolution threshold.

Further, the priorities are determined in a manner that the small document files have higher priority levels than the multiple segmented documents and the multiple segmented document files are process in an order of first-in-first-out order.

The processor of the system is further configured to, for large documents that are divided into the multiple segmented document files, insert a marker into each of the multiple segmented document files, wherein the marker defines a location of individual segmented document file in the large documents and is used to track segments that belong to a same document, and after the OCR performances are completed, concatenate all of the multiple segmented document files after OCR to restore the large documents according to the marker of each of the multiple segmented document files, wherein the restored large documents are PDF searchable documents.

### BRIEF DESCRIPTION OF THE DRAWINGS

Various other features and attendant advantages of the present invention will be more fully appreciated when considered in conjunction with the accompanying drawings.

FIG. 1 depicts a block diagram of a document management system in accordance with the disclosed embodiments.

FIG. 2 depicts an exemplary system for processing unloaded documents for OCR performance in accordance with the disclosed embodiments.

FIG. 3 depicts a flowchart illustrating a method for OCR processing uploaded documents in accordance with the disclosed embodiments.

FIG. 4 depicts a flowchart illustrating a method for determining and adjusting the number of OCR nodes needed to perform the OCR in accordance with one disclosed embodiment.

FIG. 5 depicts a flowchart 500 illustrating a method for managing OCR performance for incoming documents in accordance with the disclosed embodiments.

FIG. 6 depicts a flowchart illustrating a method for assigning OCR nodes based on the OCR processing time in accordance with the disclosed embodiments.

FIG. 7 depicts a flowchart illustrating a method for managing the OCR performance on uploaded documents in accordance with the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a document management system and method for improving the efficiency of performing OCR (Optical Character Recognition) on multiple uploaded documents. The OCR is a technology that scans documents to convert them from non-searchable format to searchable format. The OCR processing is asynchronous and the time it takes to process each uploaded document varies based on a file size and resolution (DPI) of its content. For large sized and/or high-resolution files, the process can take a long time especially if a large number of files are queued for the OCR processing. To avoid a longer processing time the large documents may cause, the disclosed embodiments could split large documents into several segmented small document files before sending them to an OCR node for processing. The several segmented small documents files may be processing in parallel in multiple OCR nodes. Each of the several segmented small documents may be inserted or embedded with a marker so that after the OCR processing, the several segmented small document files may be combined together based on the embedded markers to restore the original documents with a searchable format. The disclosed embodiments greatly reduce the processing time for large documents.

The disclosed embodiments further provide a document management system and method for monitoring the number of incoming files and scaling up the OCR resources with an auto-scaling mechanism. If the usage pattern is predictable based on an industry segment, cyclicality and/or seasonality, then the OCR resources can be proactively scaled up or down to optimize the OCR processing. The system and method in accordance with the disclosed embodiments further categorize the uploaded documents based on their file size and resolution and prioritize the OCR resources before sending them to at least one OCR node for processing.

The disclosed embodiments preset a file size threshold used to determine whether an uploaded document is a large document. A file size of a document may be determined by a page count (i.e., the number of pages) and a resolution of the uploaded document. The file size threshold is thus determined based on the page count and the resolution of the uploaded document. For the purpose of illustration, the threshold parameter for the page count (i.e., page count limit) may be 10 pages and the threshold parameter for the resolution (i.e., resolution limit) may be 300 dpi. Therefore, if the file size of document has a page count larger than 10 pages and the resolution of the document is larger than 300 dpi, this document is considered as a large document and will be split into smaller document files. A formula for calculating how many document files can be split from a large document will be n=Roundup of [(page count*dpi)/(page count limit*dpi limit)]. For example, an uploaded document with 20 pages and 300 dpi can be split to two document files, an uploaded document with 20 pages and 600 dpi can be split into 4 document files, and so on.

By splitting large documents into multiple segmented small document files and performing OCR on the multiple document files instead of a sequence of large and small documents, the processing time for performing the OCR on a bulk of uploaded documents can be greatly reduced. The disclosed embodiments split a large document that is greater than the file size threshold into multiple segmented small document files and insert or embed markers on the multiple segmented document files. Each of the markers indicates a location and/or an order of respective segmented document file in the same large document. After all of the segmented document files have run through the OCR node, the multiple segmented document files are merged back together to restore the original document in a searchable PDF format based on the markers embodied therein. The markers may be identifiers, indexes, or metadata that can be stored in a memory cache. The markers then will be deleted after the large document or all of the large documents are processed completely or reset by a user.

The disclosed embodiments may also calculate or estimate a total file size of document files received in an OCR job queue to determine how many OCR nodes are needed to process the currently existing documents files saved in the OCR job queue. In addition to the calculation or estimation of the total file size, the disclosed embodiments may further predict or estimate a total OCR processing time for those document files saved in the OCR job queue to determine the number of OCR nodes needed for OCR-processing all of those document files.

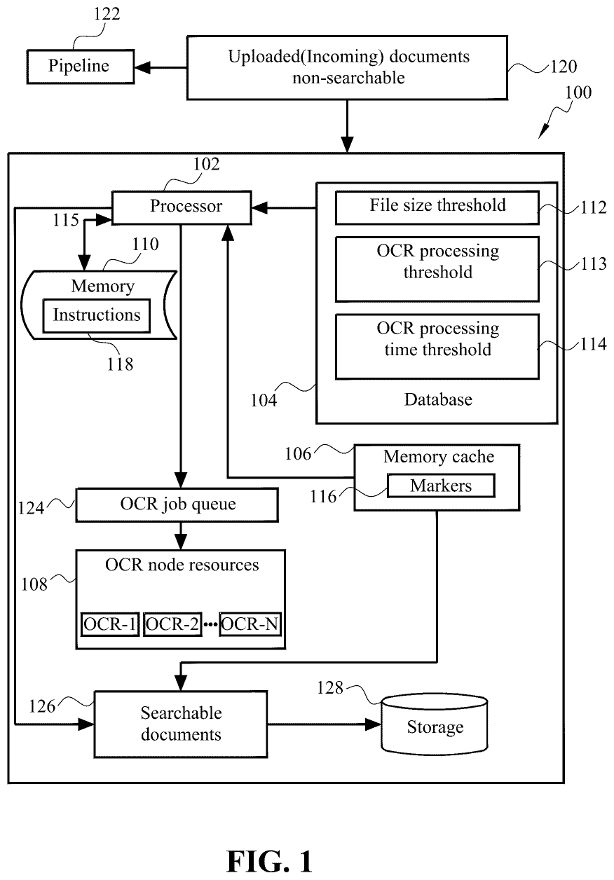

FIG. 1 illustrates a block diagram of a document management system 100 according to the disclosed embodiments. Document management system 100 receives and processes a bulk of uploaded or incoming non-searchable documents 120 before sending them to OCR node resource for the OCR performance.

Document management system 100 includes a processor 102 that is connected to memory 110 by data bus 115. Memory 110 includes instructions 118. Instructions 118 may be code that, when read by processor 102, configures system 100 to perform the operations disclosed herein. System 100 also includes a database 104 that stores a file size threshold 112 that is used by processor 102 to determine a category of uploaded documents 120. As described previously, file size threshold 112 is predetermined based on the page count and the resolution of an uploaded or incoming document. Processor 102 is configured to determine the file sizes of uploaded documents 120 and categorize them based on file size threshold 112. An uploaded document with page count and/or the resolution over file size threshold 112 will be categorized as a large document. In this case, the large document will be divided or split into a number of segmented small documents, each of which the file size is smaller than file size threshold 112. These number of segmented small documents will be sent to at least one OCR node in a form of document files for processing. Documents of which the file sizes are not greater than file size threshold 112 are categorized as small documents. Small documents will not split and they will be sent, as document files, to at least one OCR for processing. The number of segmented small documents and the small document files may also be sent to an OCR job queue 124.

When a large document is split to a number of segmented small documents, processor 102 is further configured to generate markers 116 indicating locations and/or orders of the number of segmented small documents in the original large document and to insert or embed markers 116 to corresponding segmented small documents. Markers 116 are used to aggregate the number of segmented small documents into the original large document after all of the number of small documents are processed by the OCR. All of markers 116 belonging to a same large document will be stored together in a memory cache 106 and will be deleted after the aggregation of the same large document is completed.

Processor 102 may be coupled to OCR node resources 108. OCR node resources 108 may be cloud-based available OCR nodes that may be saved in database 104 or a separate database (not shown.) OCR job queue 124 is coupled to OCR node resources 108. Upon receiving a control signal from processor 102, OCR node resources 108 may assign at least one OCR node, such as OCR-1, OCR-2, . . . , and OCR-N, to perform the OCR process. OCR node resources 108 may also assign more OCR nodes or reduce the number of OCR nodes based on an OCR processing threshold 113 and an OCR processing time threshold 114 stored in database 104. OCR processing threshold 113 and OCR processing time threshold 114 are used for processor 102 to determine a workload of OCR node resources 108. OCR processing threshold 113 is a predetermined maximum total file size of the document files that a single OCR node can perform within a predetermined period of time. In this embodiment, processor 102 may calculate the total file size of the document files sent to OCR job queue 124 and compare that with OCR processing threshold 113. If the total file size of the document files in OCR job queue 124 exceeds OCR processing threshold 113, which means that a first OCR node, such as OCR-1, reaches a maximum file size that it can process within the predetermined period of time, processor 102 may control OCR node resources 108 to assign at least one additional OCR node, such as OCR-2, to perform the OCR on extra file size of the document files that are overloaded to the OCR job queue 124.

Processor 102 may also monitor the total file size of the document files received in OCR job queue 124 after a preset period of time to determine if a current total file size is still larger than OCR processing threshold 113. When the total file size is no longer larger than OCR processing threshold 113, processor 102 may control OCR node resources 108 to reduce the number of OCR nodes. As a faster OCR processing time is preferable when a batch of documents are uploaded to system 100 at the same time, such a manner may improve the OCR performance in a much more efficient way. In some embodiments, the first OCR node and the at least one additional OCR node may perform the OCR on the document files parallelly to further improve a total OCR processing time.

The workload of the OCR node resources 108 may also be determined by OCR processing time threshold 114. OCR processing time threshold 114 is a predetermined maximum processing time a single OCR node is preferred to process the document files sent to OCR job queue 124. In this embodiment, processor 102 may predict or estimate a total processing time of performing the OCR on all the document files received in OCR job queue 124 and compare it with OCR processing time threshold 114. If the predicted or estimated total processing time is greater than OCR processing time threshold, process 102 would control OCR node resources 108 to assign at least one additional OCR node to assist the OCR process on some of the document files. Same as above, processor 102 may monitor the total processing time of the document files received in OCR job queue 124 after a preset period of time to determine if a current total processing time is still larger than OCR processing time threshold 114. When the current total processing time is no longer larger than OCR processing time threshold 114, processor 102 may control OCR node resources 108 to reduce the number of OCR nodes.

According to the disclosed embodiments, the OCR node is released when a current batch of document files are processed. Processor 102 may also monitor a pipeline 122 of uploading or incoming documents 120 and calculate the total file sizes of the uploading and incoming documents to maintain, upscale, or downscale the number of OCR nodes until the OCR nodes are no longer needed.

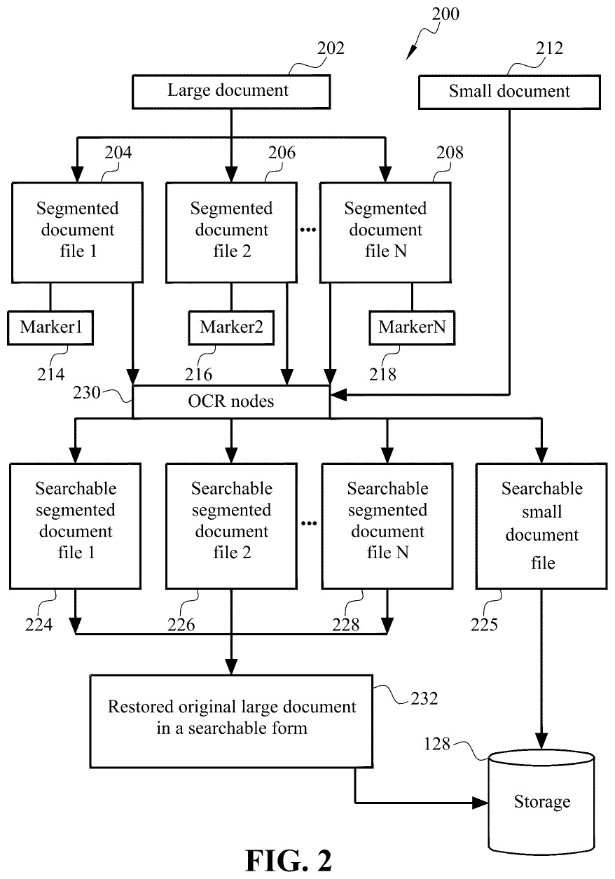

OCR node resources 108 process the document files received in OCR job queue 124 to generate searchable document files 126. The searchable document files may be PDF files that have same content as the original document files, but in a searchable form. As described above, some of the searchable document files are split from at least one large document. Therefore, before saving these split searchable document files to storage 128, processor 102 will concatenate or aggregate these split searchable document files to restore their respective large documents based on markers 116 embedded therein. Details of restoring large documents will be described in more details in FIG. 2.

As the categorization of the uploaded documents and the segmentation of the large documents are done before the uploaded documents are sent to OCR node resources 108 for processing, the time it takes to perform the OCR for the uploaded documents can be greatly reduced. Furthermore, the disclosed embodiments monitor pipeline 122 for the incoming documents and categorizes the incoming documents to predict how many OCR nodes may be needed for the incoming documents in addition to currently-processing uploaded documents 120.

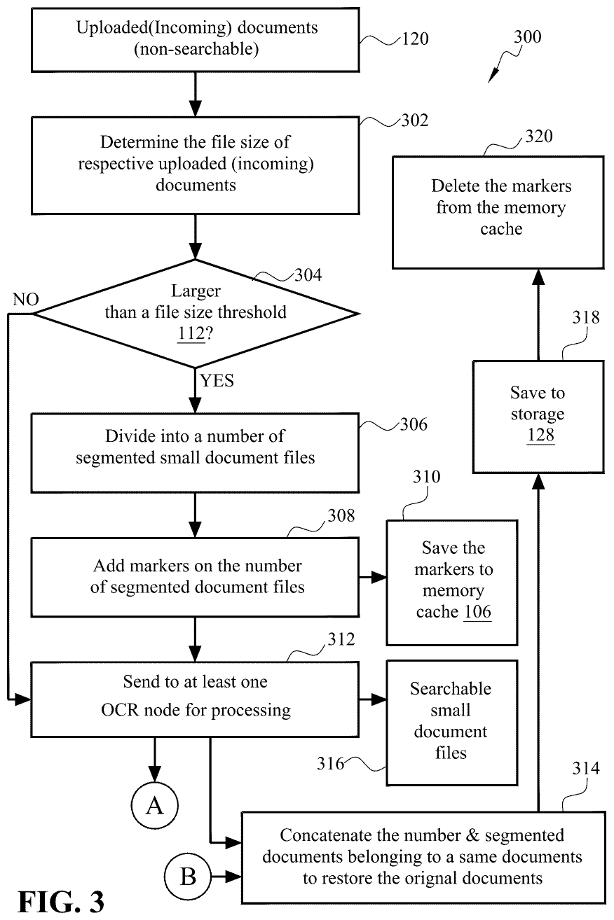

FIG. 2 illustrates an exemplary system 200 for processing unloaded documents for OCR performance in accordance with the disclosed embodiments. FIG. 2 shows that a large document 202 is pre-processed before being sent to an OCR node and is post-processed after an OCR performance to restored its original content. It is noted that FIG. 2 does not show how to determine whether the uploaded documents are large documents or small documents, as the categorizing will be described further in FIGS. 3, 5, and 7.

In general, large documents 202 shown in FIG. 2 are documents with file sizes over file size threshold 112 and small document 212 are documents with file sizes not greater than file size threshold 112. To simply, only one large document 202 and one small document 212 are shown in FIG. 2. Both of large document 202 and small document 212 are in a non-searchable form.

Small document 212 will be directly sent to at least one OCR node 230 for the OCR processing to generate searchable small document file 225. Large document 202, however, is first split into a number of segmented small document files 204, 206, and 208. Each of the segmented small document files is inserted or embedded with a marker 214, 216, and 218. The markers may be metadata, identifiers, or indexes that indicate the locations and/or orders of the segmented small document files are in large document 202. Markers 214, 216, and 218 may be stored in a memory cache (106 of FIG. 1) and will be deleted after large document 202 is restored or be reset by a user. Afterward, the number of segmented small document files are sent to OCR nodes 230 for processing. OCR nodes 230 process the OCR on the number of segmented small document files to generate searchable PDF files 224, 226, and 228. Next, based on markers 214, 216, and 218 embedded in the number of segmented small document files 204, 206, and 208, the number of segmented small document files 204, 206, and 208 are concatenated back to restore the large document in a searchable format. Both of restored original large document in a searchable form 232 and searchable small document file 225 are stored in storage 128 for future uses.

FIG. 3 illustrates a flowchart 300 showing a method for OCR-processing uploaded documents in accordance with the disclosed embodiments. To simply, same elements mentioned in previous FIGS. 1 and 2 will be marked with same reference numbers. Uploaded document or incoming document 120 are non-searchable documents. For example, uploaded document or incoming document 120 may be a non-searchable scanned PDF file.

Step 302 executes by determining the file sizes of uploaded or incoming documents 120. As defined above, each of the file sizes of documents 120 may be determined by a page count and a resolution of each of documents 120.

Step 304 executes by comparing the file size of an uploaded documents with file size threshold 112. If the answer is No, then the compared uploaded document is categorized as a small document and is sent to at least one OCR node for the OCR processing, as shown in step 312. The OCR processing generates searchable small document files 316.

If, however, the answer of step 304 is Yes, the compared document is categorized as a large document. Therefore, step 306 executes by dividing or splitting the large document into a number of segmented small document files. Meanwhile, step 308 executes by generating and inserting or embedding markers to the number of segmented small document files. Markers define the locations and orders of the number of segmented small document files in the large document. Step 310 executes by saving all markers to memory cache 106. The markers that belong to a same large document will be saved together in memory cache 106.

Next, step 312 executes by sending the number of segmented small document files to at least one OCR node for processing. The number of segmented small documents files and the small document files defined at step 306 are sent an OCR job queue (i.e., OCR job queue 124 of FIG. 1.)

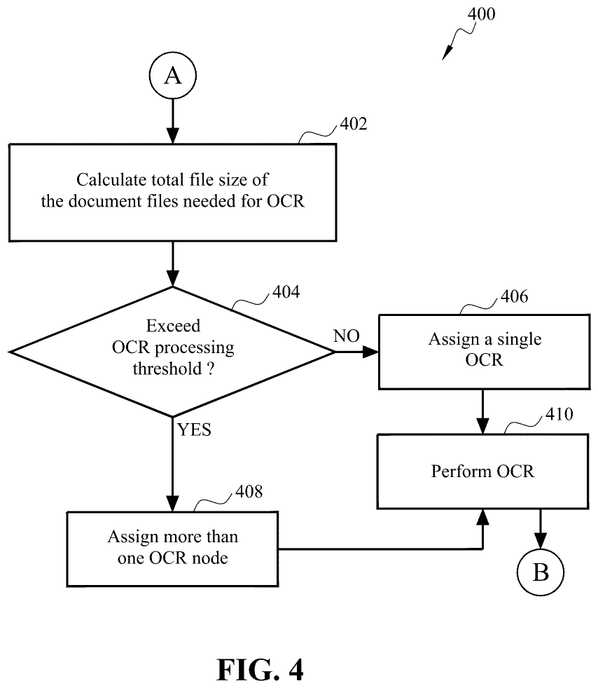

In some embodiments, method 300 may decide whether a single OCR node is sufficient to process the OCR on all of document files sent to OCR job queue 124. In this case, flowchart 300 goes to flowchart 400 of FIG. 4.

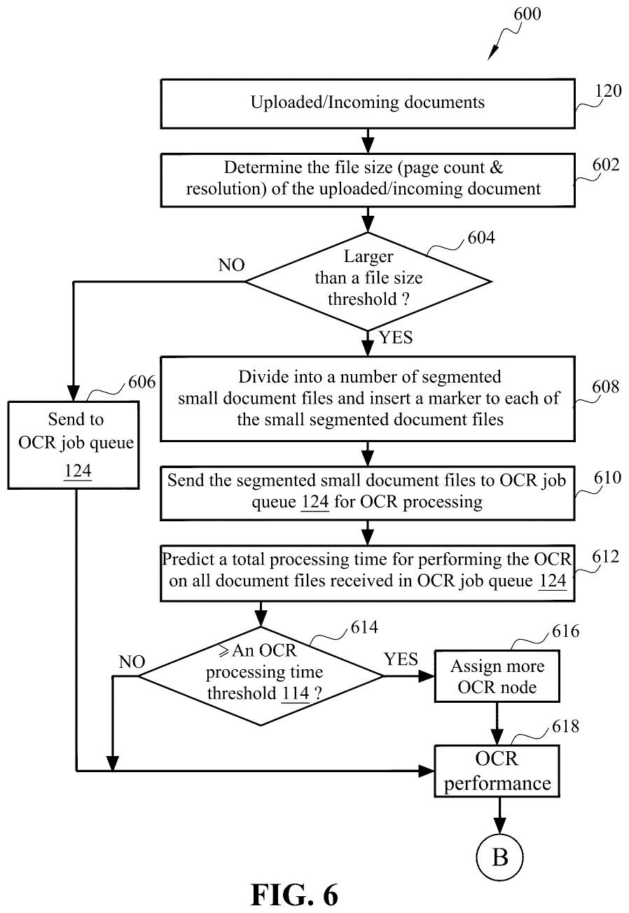

FIG. 4 illustrates a flowchart 400 showing a method for determining and adjusting the number of OCR nodes needed to perform the OCR in accordance with one disclosed embodiment. In this embodiment, the determination and adjustment of the number of OCR nodes are based on a total file size of all document files received at OCR job queue 124. However, the disclosed embodiments are not limited to the file size only. The determination and adjustment of the number of OCR nodes may also depend on a total processing time of all document files received at OCR job queue 124. The latter embodiment will be described in FIG. 6 below.

Step 402 executes by calculating a total file size of the document files received at OCR job queue 124, that is, a total size of the document files for the OCR processing.

Step 404 executes by determining whether the total file size of the document files exceeds OCR processing threshold 113. As described in FIG. 1, OCR processing threshold 113 is a predetermined maximum total file size of the document files that a single OCR node can perform within a predetermined period of time. If the answer of step 404 is NO, then only one single OCR node will be sufficient to perform the OCR on all document files received in OCR job queue 124. Step 406 then executes by assigning a single OCR for the OCR performance.

If the answer of step 404 is YES, which means a single OCR node is not sufficient to perform the OCR on all document files received in OCR job queue 124. Therefore, step 408 executes by assigning more than one OCR node for the OCR performance.

After an appropriate number of OCR nodes is assigned, step 410 executes by performing OCR on all document files in OCR job queue 124 to generate a plurality of searchable document files.

Now back to FIG. 3, after all document files in OCR job queue 124 are processed with at least one OCR node and a plurality of searchable document files are generated, step 314 executes by concatenating all segmented small document files that belong to a same large document based on their locations and orders defined by markers embedded therein to restore the same large document in a searchable form.

Step 318 executes by storing the restored searchable large document and the searchable small document 316 to storage 128 for further use. After all of the segmented small document files are OCR-processed and are concatenated back to the original document from which they are split, the markers stored in memory cache 106 will be deleted, at step 320.

In accordance with the disclosed embodiments, the system and method are not only capable of efficiently and rapidly performing the OCR processing on a batch of uploaded documents, but also capable of monitoring incoming documents to predict the workload of the OCR node resources 108 and to adjust the assignment of available OCR nodes. The prediction of the incoming workload may rely on industry segment, cyclicality and/or seasonality applicable to all existing and new clients. The prediction of incoming workload may also rely on the file sizes of the incoming documents and/or estimated OCR processing time for performing OCR on all incoming documents.

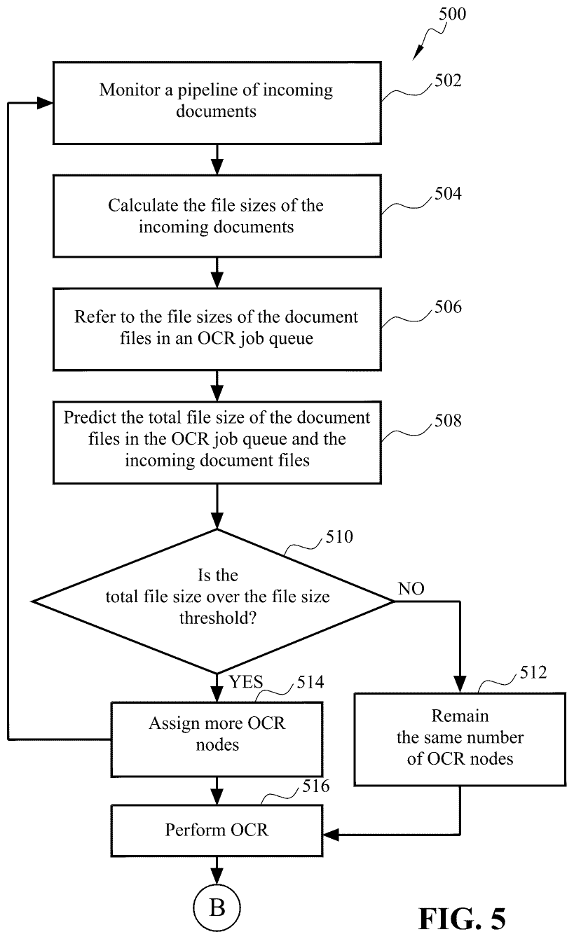

FIG. 5 illustrates a flowchart 500 showing a method for managing OCR performance for incoming documents in accordance with the disclosed embodiments. The embodiment of FIG. 5 further take consideration of currently existed uploaded documents to determine the workload and the number of OCR nodes needed to perform the OCR on both of the incoming documents and the currently existed uploaded documents. However, alternative embodiments where flowchart 500 only consider the incoming documents are also permitted.

In flowchart 500, step 502 executes by monitoring pipeline 122 for incoming documents. Monitoring pipeline 122 may be done periodically or in demand.

Step 504 executes by estimating or calculating the file sizes of the incoming documents. Step 506 executes by referring to the file sizes of the uploaded documents that are already sent to OCR job queue 124 to obtain a total file size of the incoming documents and the uploaded documents in OCR job queue 124.

Next, step 510 executes by determining if the total file size is greater than file size threshold 112. If the answer is NO, meaning that the workload of the currently used OCR nodes is not high, step 512 executes by maintaining same number of OCR nodes currently used. If the answer is YES, indicating that the workload of the currently-used OCR nodes is high, the step 514 executes by assigning at least one additional OCR node.

It is noted that flowchart 500 of FIG. 5 may periodically, or by demand, monitor the incoming documents so as to scale up and down the number of OCR nodes needed, thereby a more efficient and cost-effective method is provided.

After the number of OCR nodes needed are assigned, step 516 executes by performing the OCR on the document files received in OCR job queue 124. As described in FIG. 3, after the OCR performance is completed, the method of FIG. 5 will concatenate all segmented small document files to restore their original large documents based on markers inserted therein as shown in steps 314 to 320 of FIG. 3.

In addition to the total file size of document files received in OCR job queue 124, the determination of the workload of OCR nodes may also rely on the OCR processing time of the document files in OCR job queue 124, as in the embodiments illustrated in FIG. 6.

FIG. 6 depicts a flowchart 600 showing a method for assigning OCR nodes based on the OCR processing time in accordance with the disclosed embodiments. Flowchart 600 starts with receiving uploaded and/or incoming documents 120.

Step 602 executes by determining the file size of each of uploaded/incoming documents 120. As defined, the file size is determined based on a page count and resolution of each document.

Step 604 executes by determining if the file size of each uploaded/incoming document is greater than file size threshold 112. For those documents of which the file sizes are not greater than file size threshold 112 (i.e., NO,) step 606 will executes by sending those documents to OCR job queue 124. These documents will be categorized as small documents. For those documents of which the file sizes are greater than file size threshold 112 (i.e., YES,) those documents are categorized as large documents and need to be pre-processed before being sent to the at least on OCR node for processing.

Therefore, step 608 executes by dividing or splitting each of the large documents into a number of segmented small document files. Step 608 further executes by generating and inserting markers to the number of segmented small document files. Each of the markers indicates a location and an order of a segmented small document file relative to a large document it belongs to. All the markers will be stored in memory cache 106 for further use.

Step 610 executes by sending the segmented small document files to OCR job queue 124.

Next, step 612 executes by predicting a total OCR processing time for all document files, including small document files and segmented small document files, received in OCR job queue 124.

Step 614 executes by determining if the total processing time is greater than OCR processing time threshold 114. If the answer is NO, flowchart 600 goes to step 618 that executes by performing OCR on the document files in OCR job queue 124. If the answer is YES, indicating that the workload of the OCR node resources 108 is high, step 616 will execute by assigning at least one additional OCR node to handle the OCR performance on all document files in OCR job queue 124.

The rest of flowchart 600 will be the same as steps 314-320 of FIG. 3. The descriptions thereof will be omitted for simplicity.

It is noted that when there are more than one OCR nodes in use to perform the OCR, it is preferable that the segmented small document files of a same large document are sent to different OCR nodes for processing in parallel. Processing segmented small document files in parallel of a same large document further improve the processing time for the large documents. However, when only a single OCR node is used, all small document files and segmented small document files will be sent to the single OCR node for processing. In this case, if the segmented small document files are queued in the front of the job queue, a client will experience a longer waiting time as the segmented small document files, after the OCR performance, will need to be combined together with other segmented small document files belonging to a same large document. If the segmented small documents are not queued in order, it will even take more time to restore their original large document. To avoid this from happening, the disclosed embodiments may prioritize the document files sent to OCR job queue 124. In general, the disclosed embodiments would prioritize the small document files (i.e., small documents 204 of FIG. 2) over the segmented small document files, and prioritize the small document files with smaller file size over the small document files with larger file size. In some embodiments, the disclosed embodiment would process the segmented small documents in a first-come-first-serve manner or alternatively process small document files with segmented small document files.

The above-described flowcharts 200, 300, 400, 500, and 600 may be executed by processor 102 of system 100 of FIG. 1 caused by the executions of instructions 118 of memory 110, but not limited thereto. Any analog and/or digital circuitries that are capable of executing the flowcharts of FIGS. 2-6 may also be used in the disclosed embodiments.

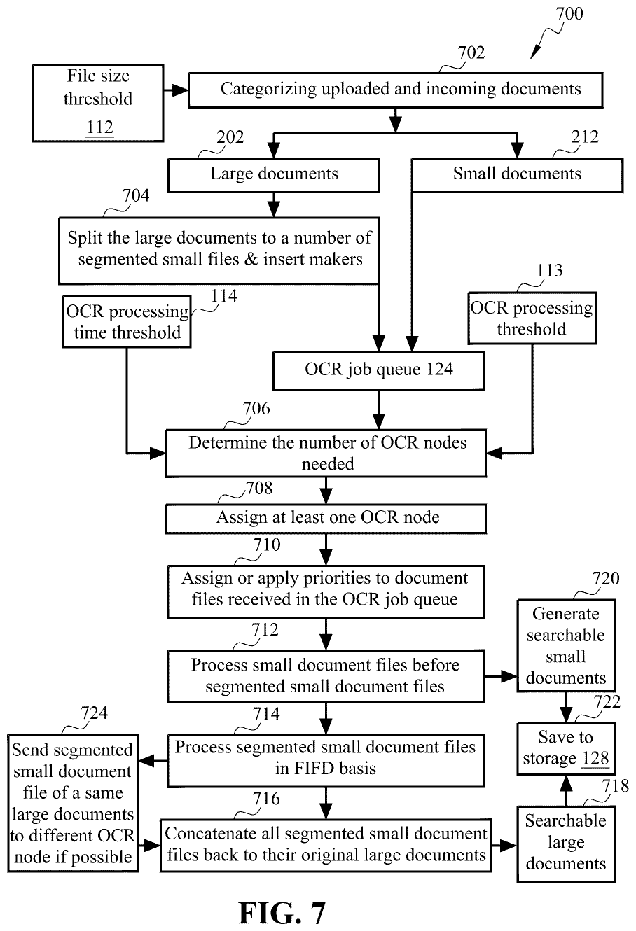

FIG. 7 depicts a flowchart 700 illustrating a method for managing the OCR performance on uploaded documents in accordance with the disclosed embodiments. Flowchart 700 shows a process of categorizing uploaded and incoming documents, determining the number of OCR nodes needed for the OCR performance, prioritizing the uploaded and incoming documents, and concatenating segmented small documents to restore their original large documents.

Step 702 executes by categorizing uploaded and incoming documents, such as documents 120 of FIG. 1. The categorization of the uploaded and incoming documents is done based on their file sizes in comparison with the file size threshold 112. After the categorization step, the uploaded and incoming documents are categorized as large documents 202 and small documents 204. As described before, large documents 202 are documents of which the file sizes are greater than file size threshold 112 and small documents 204 are documents of which the file sizes are not greater than file size threshold 112. Small documents 204 will be sent to OCR job queue 124 as small document files without pre-processing. Large documents 202 will be processed at step 704.

Step 704 executes by splitting each of large documents 202 into a number of segmented small document files and inserting markers to the number of segmented small document files. The markers may be identifiers, indexes, or metadata that indicates locations and orders of the segmented small document files in their respective original large documents. After that, all the segmented small document files are sent to OCR job queue 124.

Step 706 executes by determining the number of OCR nodes needed to process the document files sent to OCR job queue 124. As described previously, the determination standards are to compare a total file size of the document files in OCR job queue 124 with a pre-determined OCR processing threshold, such as OCR processing threshold 113, or to compare a total estimated OCR processing time of the document files in OCR job queue 124 with a pre-determined OCR processing time threshold, such as OCR processing time threshold 114. These procedures have been described in FIGS. 1, 5, and 6.

Afterward, step 708 executes by assigning at least one OCR node based on the comparison result obtained at step 706.

Before performing the OCR on the document files, step 710 further executes by assigning priorities to documents files received in OCR job queue 124. The priority assignment may be preset and saved in a priority list (not shown) stored in database 104 of system 100. The priority list may also be configurable based on individual requirements of the clients/user of system 100. In the exemplary embodiment of FIG. 7, the priority levels of the document files are set before performing the OCR, but not limited thereto. Further, the priority levels stated at the following steps 710, 722, and 724 are basic rules for example only. The priority levels may be configurable according to the requirements of each user/client of system 100.

Step 710 executes by assigning or applying priorities to the document files received in OCR job queue 124. According to the disclosed embodiments, small document files (i.e., those of which the file sizes are not greater than file size threshold 112) get higher priorities. Among the small document files, a small document file will have a higher priority if the file size thereof is smaller. Therefore, step 712 executes by processing small document files first before processing segmented small documents. Step 714 executes by processing the segmented document files in a first-in-first-out (FIFO) or a first-come-first serve manner. In some embodiments, the OCR node may alternatively process a first predetermined number of small document files and a second predetermined number of segmented small document files until all document files in OCR job queue 124 are processed completely. This manner can ensure that the processing of the small document files will not get delayed by processing segmented small document files first. As segmented small document files are split from one or more large document, after the segmented small documents files are OCR-processed, they will have to be combined together to restore the original large documents they belong to, which will take a bit longer time. In contrast, the small document files are stand-alone documents. After the OCR-processing, the small document files will be transferred to searchable documents with immediately, as shown in step 720.

When more than one OCR nodes are used for processing the OCR, flowchart 700 may send segmented small document files of a same large document to different OCR nodes for processing if possible, as shown in step 724. This way allows more than one segmented small document files of the same large document to be OCR-processed parallelly or at substantially same time to further reduce the processing time of the same large document.

After all the document files in OCR job queue 124 are processed by the at least one OCR node to become searchable segmented small document files, step 716 executes by concatenating the searchable segmented small document files based on the markers embedded therein to restore the original large documents they are split from, as shown in step 718.

Last, step 722 executes by saving the searchable large document generated at step 718 and the searchable small documents generated at step 720 to storage 128.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for improving optical character recognition (OCR) performances of a plurality of uploaded documents, the method comprising:
categorizing the plurality of uploaded documents based on a predetermined threshold to categorize large documents and small documents, wherein the large documents are larger than the predetermined threshold and the small documents are no greater than the predetermined threshold;
sending the small documents, as small document files, to an OCR job queue;
dividing each of the large documents into multiple segmented document files, wherein each of the multiple segmented documents is no greater than the predetermined threshold;
sending the multiple segmented document files to the OCR job queue;
determining priorities of the small document files and the multiple segmented document files of each of the large documents; and
performing the OCR on the small document files and the multiple segmented document files on at least one OCR node based on the priority.

2. The method of claim 1, wherein the predetermined threshold is determined based on a page count limit and a resolution limit, and wherein the threshold is saved in configuration file relative to a cluster of OCR nodes.

3. The method of claim 1, further comprising:
inserting markers into the multiple segmented document files after the large documents are divided, wherein each of the markers defines a location of individual segmented document file in the large documents and are used to track segments that belong to a same document; and
after the OCR performances are completed, concatenating the multiple segmented document files after OCR to restore the large documents according to the markers, wherein the restored documents are PDF searchable documents.

4. The method of claim 3, wherein the markers belonging to the same large document are saved together in a database and are discarded after the OCR performance is completed and all the multiple segmented document files are combined to restore the same large document based on the markers.

5. The method of claim 2, wherein the large documents are divided based on their file sizes in relative to the predetermined threshold, the file sizes are calculated based on a page count and a resolution.

6. The method of claim 1, wherein the priorities are determined in a manner that the small document files have higher priority levels than the multiple segmented documents and the multiple segmented document files are processed in an order of first-in-first-out order.

7. The method of claim 1, wherein if only one OCR node is used for processing the OCR, the OCR node processes the small document files first and then the multiple segmented document files.

8. The method of claim 1, wherein if there are more than one OCR node, further comprising sending the multiple segmented document files to different OCR nodes for processing.

9. The method of claim 1, if the at least one OCR node has reached maximum number of OCR jobs the at least one OCR node is able to handle, further comprising assigning at least one additional OCR node to perform the OCR.

10. The method of claim 1, wherein the priorities are determined based on processing time of each of the small document files and the multiple segmented document files.

11. A method for improving optical character recognition (OCR) performances on a plurality of uploaded documents, the method comprising:
categorizing the plurality of uploaded documents based on their file sizes in comparison with a predetermined threshold, wherein documents having the file sizes are larger than the predetermined threshold are considered as large documents and documents having the file sizes no greater than the predetermined threshold are considered as small documents;
sending the small documents as small document files to an OCR job queue;
dividing each of the large documents into multiple segmented document files, wherein each of the multiple segmented documents is no greater than the predetermined threshold;
inserting markers into the multiple segmented document files, wherein each of the markers defines a location of individual segmented document file in the large documents and are used to track segments that belong to a same document;
sending the multiple segmented document files to the OCR job queue;
distributing the small document files and the multiple segmented document files to at least one OCR node; and
performing the OCR on the small document files and the multiple segmented document files; and
after the OCR performances are completed, concatenating the multiple segmented document files after OCR to restore the documents according to the markers of the number of segmented documents, wherein the restored documents are PDF readable documents.

12. The method of claim 11, wherein each of the file sizes is calculated from a page count and a resolution, and the predetermined threshold are determined based on a page count limit and a resolution limit, and the predetermined threshold is saved in configuration file relative to a cluster of OCR nodes.

13. The method of claim 11, further comprising determining priorities of the small document files and the multiple segmented document files of each of the large documents.

14. The method of claim 13, wherein the priorities are determined in a manner that the small document files have higher priority levels than the multiple segmented documents and the multiple segmented document files are processed in an order of first-in-first-out order.

15. The method of claim 11, wherein if only one OCR node is used for processing the OCR, the OCR node processes the small document files first and then the multiple segmented document files.

16. The method of claim 11, wherein if there are more than one OCR node, further comprising sending the multiple segmented document files to different OCR nodes for processing.

17. A system for performing optical character recognition (OCR) on bulk uploaded document, the system comprising:
a storage for storing a plurality of uploaded documents;
a managing device accessible to the plurality of uploaded documents stored in the storage, comprising a processor, wherein the storage further stores medium-readable instructions, which when executed, causes the processor to:
categorize the plurality of uploaded documents based on a predetermined threshold to categorize large documents and small documents, wherein the large documents are larger than the predetermined threshold and the small documents are no greater than the predetermined threshold;
send the small documents, as small document files, to an OCR job queue;
divide each of the large documents into multiple segmented document files, wherein each of the multiple segmented documents is equal or less than the predetermined threshold, and the multiple segmented document files are considered as small documents;
send the multiple segmented document files to the OCR job queue;
determine priorities of the small document files and the multiple segmented document files of each of the large documents; and
perform the OCR on at least one OCR node on the small document files and the number of segmented document files based on the priority.

18. The system of claim 17, wherein the large documents are divided based on the predetermined threshold, and the predetermined threshold includes a page count threshold and a resolution threshold.

19. The system of claim 17, wherein the priorities are determined in a manner that the small document files have higher priority levels than the multiple segmented documents and the multiple segmented document files are process in an order of first-in-first-out order.

20. The system of claim 17, wherein the processor is further configured to
for large documents that are divided into the multiple segmented document files, insert a marker into each of the multiple segmented document files, wherein the marker defines a location of individual segmented document file in the large documents and is used to track segments that belong to a same document; and
after the OCR performances are completed, concatenate all of the multiple segmented document files after OCR to restore the large documents according to the marker of each of the multiple segmented document files, wherein the restored large documents are PDF searchable documents.
